(19) United States
(12) Patent Application Publication
(10) Pub. No.: US 2019/0051435 A1
(43) Pub. Date: Feb. 14, 2019

(54) SINTERED R-T-B BASED PERMANENT MAGNET AND A METHOD OF MAKING THE SINTERED R-T-B BASED PERMANENT MAGNET

(71) Applicant: Yantai Shougang Magnetic Materials, Inc., Yantai (CN)

(72) Inventors: Kaihong Ding, Yantai (CN); Zhongjie Peng, Yantai (CN); Zhanji Dong, Yantai (CN); Xiulei Chen, Yantai (CN)

(21) Appl. No.: 16/100,107

(22) Filed: Aug. 9, 2018

(30) Foreign Application Priority Data
Aug. 10, 2017 (CN) 201710678374.2

(51) Int. Cl. H01F 1/057; H01F 7/02; H01F 41/02

(52) U.S. Cl. CPC H01F 1/0577; H01F 41/0293; H01F 7/02

(57) ABSTRACT

A sintered R-T-B based permanent magnet includes a body having an easy-axis of magnetization. The body has a plurality of R₂T₁₄B main phases spaced from one another and a plurality of grain boundary phases between the R₂T₁₄B main phases. The body including zero heavy rare earth elements and the grain boundary phases includes a first and a second grain boundary phase. The first grain boundary phase is disposed between the R₂T₁₄B main phases and extends along and parallel to the easy-axis of magnetization whereby the first grain boundary phase forms a plurality of first grain boundary triple point areas with the first grain boundary triple point areas being a rare earth element rich phase having a high content of Al and Ga and includes 65 at. %≤Pr+Nd≤88 at. %, 10 at. %≤Al+Ga≤25 at. %, O≤10 at. %, and Fe+Cu+Co≤2 at. %. A method of making the sintered R-T-B based permanent magnet is disclosed herein.

### CROSS REFERENCE TO RELATED APPLICATION

This application claims priority to Chinese application serial number CN201710678374.2 filed on Aug. 10, 2017, the entire disclosure of which is incorporated herein by reference in its entirety.

### BACKGROUND OF THE INVENTION

### 1. Field of the Invention

The present invention generally relates to a sintered R-T-B based permanent magnet and a method of making the sintered R-T-B based permanent magnet.

### 2. Description of the Prior Art

Currently, R-T-B (wherein R is at least one rare earth element such as, but not limited to, Pr, Nd, Dy, and Tb; T is at least one transition metal such as, but not limited to, Fe and Co; B is at least one element selected from B or N) based sintered permanent magnetic materials have been widely used in the applications of computers, new energy vehicles, medical and wind power generators. Due to an increase in the price of heavy rare earth elements, e.g. Dy and Tb, there is an increase in demand for rare earth permanent magnets with high coercivity with less or no heavy rare earth element.

To reduce the use of heavy rare earth elements and maximize the coercivity of the rare earth permanent magnets, grain boundary diffusion techniques of pure metals, heavy rare earth elements, two-phase or multiphase alloys, oxide or fluoride can be used. The advantage of these techniques is that, by introducing less than 1% of the heavy rare earth elements to the rare earth permanent magnets, the coercivity of the rare earth permanent magnets can be increased to be equivalent to a conventional rare earth magnet containing 5% to 10% of heavy rare earth elements thereby saving a significant amount of the heavy rare earth elements. However, the biggest disadvantage of grain boundary diffusion process is that it cannot be applied to rare earth permanent magnets having a thickness greater than 5 mm. This is because the diffusion process is greatly affected by the thickness of the rare earth permanent magnets. Therefore, in some fields, such as New Energy Vehicles, the application of the grain boundary diffused rare earth permanent magnets is limited.

According to Japanese Patent Application JP2015-5767788, the addition of Ga to a sintered Nd—Fe—B magnet without heavy rare earth elements can significantly increase the coercivity because of the formation of Nd₆(FeGa)₁₄ phase (“6:14 phase”) in the grain boundary triple point areas. In addition, as reported in literature (T. T. Sasaki et al. Scripta Materialia 113 (2016) 218-221), the grain boundary width is increased with the formation of the 6:14 phase thereby so that the magnetic effect of decoupling between adjacent main phase increases, thereby enhancing the coercivity.

Although the formation of 6:14 phase, caused by the addition of Ga, can increase the coercivity of the rare earth permanent magnets, the 6:14 phase absorbs too much rare earth elements such as Pr and Nd thereby causing the grain boundary thickness and the distribution of the rare earth elements in the rare earth permanent magnets to be non-uniform and, thus, negatively affect the squareness of the rare earth permanent magnet. In addition, although the price of the Ga is lower than that of the heavy rare earth element, e.g. Tb and Dy, the price is much higher than the price of the Nd and Pr. Therefore, without lowering the coercivity, Ga should be added as little as possible.

One such a rare earth permanent magnet is disclosed in U.S. Pat. No. 5,405,455. The rare earth permanent magnet includes a body having an easy-axis of magnetization including a plurality of R₂T₁₄B main phases and a grain boundary phase. The R₂T₁₄B main phases are spaced from one another and the grain boundary phase is disposed between the R₂T₁₄B main phases.

### SUMMARY OF THE INVENTION

The present invention overcomes the deficiencies mentioned above and provides a sintered R-T-B based permanent magnet without any heavy rare earth elements and has a higher coercivity and a specific microstructure. The present invention also provides a method of making the sintered R-T-B based permanent magnet wherein the amounts of C, O, and N are carefully controlled thereby forming a first grain boundary phase along and parallel to the easy-axis of magnetization and a second grain boundary phase along a second axis perpendicular to the easy-axis of magnetization to increase the coercivity of the sintered R-T-B based permanent magnet permanent magnet. In addition, the present invention provides a method of making the sintered rare earth magnet at a lower cost. The sintered R-T-B based permanent magnet, without heavy rare earth elements and includes minimal amount of element Ga, has a coercivity exceeding 20 kOe at room temperature and a squareness of 0.96.

It is one aspect of the present invention to provide a sintered R-T-B based permanent magnet. The sintered R-T-B based permanent magnet includes a body having an easy-axis of magnetization including a plurality of R₂T₁₄B main phases and a plurality of grain boundary phases. The R₂T₁₄B main phases are spaced from one another and the grain boundary phases are disposed between the R₂T₁₄B main phases. The body includes zero heavy rare earth elements. The grain boundary phases include a first grain boundary phase and a second grain boundary phase. The first grain boundary phase disposed between the R₂T₁₄B main phases and extends along and parallel to the easy-axis of magnetization whereby the first grain boundary phase forms a plurality of first grain boundary triple point areas. The first grain boundary triple point areas is a rare earth element rich phase having a high content of Al and Ga and including 65 at. %≤Pr+Nd≤88 at. %, 10 at. %≤Al+Ga≤25 at. %, O≤10 at. %, and Fe+Cu+Co≤2 at. %.

It is another aspect of the present invention to provide a method of making a sintered R-T-B based permanent magnet without any heavy rare earth elements. The method includes a step of providing a raw powder. The next step of the method includes forming the raw powder into a sheet. Then, the sheet is subjected to a hydrogen decrepitation process to produce a rare earth alloy powder. A lubricant is then added to the rare earth alloy powder. Next, the rare earth alloy powder is pulverized to produce a fine alloy powder. After pulverizing the rare earth alloy powder, the lubricant is further added to the fine alloy powder and the fine alloy powder including the lubricant is mixed. Then, the fine alloy powder including the lubricant is compacted and oriented an inert atmosphere to produce a green compact. After forming the green compact, the green compact is then sintered in a furnace under vacuum to obtain a sintered magnet. Next, the sintered magnet is subject to an annealing treatment. During the steps of providing the raw powder, forming the raw powder, subjecting the sheet to the hydrogen decreptitation process, adding the lubricant, pulverizing the rare earth alloy powder, further adding the lubricant, mixing, compacting, sintering, cooling the sintered magnet, and subjecting the sintered magnet to the annealing treatment, the amount impurities are controlled to limit Carbon ≤800 ppm and Oxygen ≤800 ppm and Nitrogen ≤200 ppm to produce the sintered R-T-B based permanent magnet without any heavy rare earth elements.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a demagnetization curve of the sintered R-T-B based permanent magnet of Implementing Example 1 at room temperature;

FIG. 2 is a scanning electron microscope (SEM) image of the sintered R-T-B based permanent magnet of Implementing Example 1;

FIG. 3 is a Transmission Electron Microscopy image and an electron diffraction spot image of the first grain boundary phase of the sintered R-T-B based permanent magnet of Implementing Example 1 parallel to an easy-axis of magnetization;

FIG. 4 is a Transmission Electron Microscopy image and an electron diffraction spot image of the second grain boundary phase of the sintered R-T-B based permanent magnet of Implementing Example 1 along a second axis perpendicular to the easy-axis of magnetization;

FIG. 5 is an Electron Dispersion X-ray Spectroscopy mapping of the grain boundary triple point areas of the sintered R-T-B based permanent magnet of Implementing Example 1;

FIG. 6 is a Transmission Electron Microscopy image and an electron diffraction spot image of a first grain boundary triple point (region a) and a second grain boundary triple point (region b) in FIG. 5;

FIG. 7 is a Transmission Electron Microscopy image and an electron diffraction spot image of the first grain boundary phase of the sintered R-T-B based permanent magnet of Implementing Example 2 parallel to an easy-axis of magnetization;

FIG. 8 is a Transmission Electron Microscopy image and an electron diffraction spot image of the second grain boundary phase of the sintered R-T-B based permanent magnet of Implementing Example 2 along a second axis perpendicular to the easy-axis of magnetization;

FIG. 9 is an Electron Dispersion X-ray Spectroscopy mapping of the grain boundary triple point areas of the sintered R-T-B based permanent magnet of Implementing Example 2;

FIG. 10 is a Transmission Electron Microscopy image and an electron diffraction spot image of a first grain boundary triple point (region c) and a second grain boundary triple point (region d) in FIG. 9;

FIG. 11 is a Transmission Electron Microscopy image and an electron diffraction spot image of the first grain boundary phase of the sintered R-T-B based permanent magnet of Implementing Example 3 parallel to an easy-axis of magnetization

FIG. 12 is a Transmission Electron Microscopy image and an electron diffraction spot image of the second grain boundary phase of the sintered R-T-B based permanent magnet of Implementing Example 3 along a second axis perpendicular to the easy-axis of magnetization

FIG. 13 is an Electron Dispersion X-ray Spectroscopy mapping of the grain boundary triple point areas of the sintered R-T-B based permanent magnet of Implementing Example 3; and

FIG. 14 is a Transmission Electron Microscopy image and an electron diffraction spot image of a first grain boundary triple point (region e) and a second grain boundary triple point (region f) in FIG. 13.

### DESCRIPTION OF THE ENABLING EMBODIMENT

Referring to the Figures, wherein like numerals indicate corresponding parts throughout the several views, it is one aspect of the present invention to provide a sintered R-T-B based permanent magnet.

The sintered R-T-B based permanent magnet includes a body having a composition of R-T-B-M. R is one or more rare earth elements selected from a group consisting of Pr or Nd. T is one or more transition metals selected from a group consisting of Fe or Co. B is one or more elements selected from a group consisting of B, C, O, or N. M is one or more elements selected from a group consisting of Al, Cu, or Ga. In one embodiment, R includes Praseodymium (Pr) and Neodymium (Nd). T includes Iron (Fe) and Cobalt (Co). B includes Boron (B), Carbon (C), Oxygen (O), and Nitrogen (N). M includes Aluminum (Al), Copper (Cu), and Gallium (Ga). In addition, Praseodymium and Neodymium together are present between 14.2 at. % and 15.6 at. %. Boron is present between 4.9 at. % and 7.3 at. %. Aluminum is present between 0.9 at. % and 2.0 at. %. Cobalt is present between 0.1 at. % and 1.3 at. %. Copper is present between 0.2 at. % and 0.5 at. %. Gallium is present between 0.1 at. % and 0.4 at. %. The balance is Iron. Carbon, Oxygen, and Nitrogen are considered as impurities and are present in an amount that satisfies C≤800 ppm, O≤800 ppm, and N≤200 ppm.

It should be appreciated that, the weight percentage of Praseodymium and Neodymium together are present between 31 wt. % and 34 wt. %. Boron is present between 0.8 wt. % and 1.2 wt. %. Aluminum is present between 0.4 wt. % and 0.8 wt. %. Cobalt is present between 0.6 wt. % and 1.2 wt. %. Copper is present between 0.6 wt. % and 1.2 wt. %. Gallium is present between 0.1 wt. % and 0.4 wt. %. The balance is Iron.

The body has an easy-axis of magnetization and includes a plurality of R₂T₁₄B main phases spaced from one another. It should be appreciated that, in the body, depending on the magnetic field with respect to the crystal lattice of the body, a lower or higher magnetic field is need to be applied to reach a saturation magnetization. The easy-axis of magnetization is defined as a direction in the crystal lattice of the body, along which a small applied magnetic field is sufficient to reach the saturation magnetization.

The body includes zero heavy rare earth elements and a plurality of grain boundary phases is disposed between said R₂T₁₄B main phases. In other words, the grain boundary phases are disposed in the spacing between the R₂T₁₄B main phases to separate the R₂T₁₄B main phases from one another. The grain boundary phases include a first grain boundary phase and a second grain boundary phase. The first grain boundary phase, having a face-centered cubic crystalline structure, is disposed between the R₂T₁₄B main phases and extends along and parallel to the easy-axis of magnetization. The first grain boundary phase forms a plurality of first grain boundary triple point areas between the R₂T₁₄B main phases wherein the first grain boundary triple point areas are a rare earth element rich phase having a high content of Al and Ga and have an amorphous crystalline structure. The first grain boundary triple point areas includes 65 at. %≤Pr+Nd≤88 at. %, 10 at. %≤Al+Ga≤25 at. %, O≤10 at. %, and Fe+Cu+Co≤2 at. %.

The grain boundary phases include a second grain boundary phase, having a face-centered cubic crystalline structure, disposed between the R₂T₁₄B main phases. The second grain boundary phase extends along a second axis perpendicular to the easy-axis of magnetization. The second grain boundary phase forms a plurality of second grain boundary triple point areas between the R₂T₁₄B main phases wherein the second grain boundary triple point areas are a rare earth element rich phase having a high content of Cu and Ga and have a densely hexagonal close-packed crystalline structure. The second grain boundary triple point areas includes 50 at. %≤Pr+Nd≤70 at. %, 10 at. %≤Cu+Ga≤10 at. %, O≤10 at. %, 10 at. %≤Fe+Cu+Co≤20 at. %.

It is another aspect of the present invention to provide a method of making a sintered R-T-B based permanent magnet without any heavy rare earth elements. The method includes a step of providing a raw powder. The raw powder has a composition of R-T-B-M. R is one or more rare earth elements selected from a group consisting of Pr or Nd. T is one or more transition metals selected from a group consisting of Fe or Co. B is one or more elements selected from a group consisting of B, C, O, or N. M is one or more elements selected from a group consisting of Al, Cu, or Ga. In one embodiment, R includes Praseodymium (Pr) and Neodymium (Nd). T includes Iron (Fe) and Cobalt (Co). B includes Boron (B), Carbon (C), Oxygen (O), and Nitrogen (N). M includes Aluminum (Al), Copper (Cu), and Gallium (Ga). In addition, Praseodymium and Neodymium together are present between 14.2 at. % and 15.6 at. %. Boron is present between 4.9 at. % and 7.3 at. %. Aluminum is present between 0.9 at. % and 2.0 at. %. Cobalt is present between 0.1 at. % and 1.3 at. %. Copper is present between 0.2 at. % and 0.5 at. %. Gallium is present between 0.1 at. % and 0.4 at. %.

It should be appreciated that, the weight percentage of Praseodymium and Neodymium together are present between 31 wt. % and 34 wt. %. Boron is present between 0.8 wt. % and 1.2 wt. %. Aluminum is present between 0.4 wt. % and 0.8 wt. %. Cobalt is present between 0.6 wt. % and 1.2 wt. %. Copper is present between 0.6 wt. % and 1.2 wt. %. Gallium is present between 0.1 wt. % and 0.4 wt. %. The balance is Iron.

The next step of the method includes forming the raw powder into a sheet having a thickness of between 0.2 mm and 0.5 mm. It should be appreciated that a strip casting process, e.g. a rapid condensing strip casting process, can be used to form the raw powder into the sheet having the thickness of between 0.2 mm and 0.5 mm. Next, the sheet is subjected to a hydrogen decrepitation process to produce a rare earth alloy powder. The hydrogen decreptiation process is conducted under a predetermined pressure 0.15 MPa and 0.3 MPa for a predetermined duration of 3.5 hours. During the hydrogen decrepitation process, the sheet is placed in a hydrogen decreptiation furnace. The furnace is degassed and, then, hydrogen gas is introduced into the chamber. It should be appreciated that between degassing the furnace and introducing the hydrogen gas, an inert gas, e.g. Argon gas, can be introduced into the furnace to produce a clean environment for the hydrogen decrepitation process. After introducing the hydrogen gas, the sheet absorbs and reacts with the hydrogen gas. Then, the hydrogen gas is removed from the furnace during the decreptiation process a predetermined temperature of 550° C. to produce to a rare earth alloy powder. It should be appreciated that the rare earth alloy powder can be cooled down to a room temperature.

The next step of the method includes adding a lubricant between 0.05 wt. % and 0.5 wt. % to the rare earth alloy powder. Then, the rare earth alloy powder including the lubricant is pulverized using a jet milling process to produce a fine alloy powder having an average particle size of between 2.0 μm and 3.5 μm. After pulverizing the rare earth alloy powder including the lubricant, the lubricant is further added to the fine alloy powder in an amount between 0.03 wt. % and 0.2 wt. %. Next, the fine alloy powder including the lubricant is mixed using a mixer for a mixing duration of between 1 and 2 hours.

The fine alloy powders including the lubricant are then compacted in a mold and oriented. While orienting to the fine alloy powders including the lubricant, the fine alloy powders are subjected to a magnetic field having a magnetic strength of between 2.0T and 2.5T under an inert atmosphere of Argon to produce a green compact. Next, the green compact is sintered in a furnace under vacuum at a sintering temperature ranging between 880° C. and 1030° C. and a vacuum pressure of 5×10⁻² Pa for a sintering duration of between 6 hours to 15 hours to obtain a sintered magnet.

Then, the sintered magnet is cooled to room temperature at the vacuum pressure. After cooling the sintered magnet, the sintered magnet is subjected to an annealing treatment. The annealing treatment includes a first annealing treatment and a second annealing treatment. In other words, the step of subjecting the sintered magnet to an annealing treatment is further defined as subjecting the sintered magnet to a first annealing treatment at a first annealing temperature of between 780° C. and 860° C. and the vacuum pressure. After the first annealing treatment, the first annealing temperature is maintained for a first annealing duration of 3 hours. Next, the sintered magnet is subjected to a second annealing treatment at a second annealing temperature of between 480° C. and 550° C. and the vacuum pressure for a second annealing duration of between 2 hours to 8 hours. Throughout the method of making the sintered rare earth magnet elements such as Carbon, Oxygen, and Nitrogen are regarded as impurities. During the steps of providing the raw powder, casting the raw powder, subjecting the sheet to the hydrogen decreptitation process, adding the lubricant, pulverizing the rare earth alloy powder, further adding the lubricant, mixing, compacting, sintering, cooling the sintered magnet, and subjecting the sintered magnet to the annealing treatment, the amount of impurities are carefully controlled to limit Carbon ≤800 ppm, Oxygen ≤800 ppm, and Nitrogen ≤200 ppm to produce the sintered R-T-B based permanent magnet without any heavy rare earth elements.

Implementing examples are provided below to provide a better illustration of the present invention. The implementing examples are used for illustrative purposes only and do not limit the scope of the present invention.

### Implementing Example 1

A raw powder is prepared. The raw powder includes Praseodymium (Pr) and Neodymium (Nd) being present at 15 at. %, Boron (B) being present at 5.6 at. %, Cobalt (Co) being present at 1.1 at. %, Copper (Cu) being present at 0.4 at. %, Aluminum (Al) being present at 1.0 at. %, Gallium being present at 0.2 at. %, and the balance being Iron (Fe). Converting the atomic percent to weight percent, it should be appreciated that, the weight percentage of Pr and Nd is at 32.5 wt. %. B is at 0.9 wt. %. Co is at 1.0 wt. %. Cu is at 0.4 wt. %. Al is at 0.4 wt. %. Ga is at 0.2 wt. %. The balance is Fe.

Next, the raw powder is formed into a sheet having a thickness of between 0.2 mm and 0.5 mm using a rapid condensing strip casting process. Then, the sheet is placed into a furnace and subjected to a hydrogen decrepitation process to produce a rare earth alloy powder. The hydrogen decreptiation process is conducted under a predetermined pressure 0.2 MPa for a predetermined duration of 3.5 hours. At a predetermined temperature of 550° C., hydrogen gas is removed from the furnace during the decreptiation process to produce to the rare earth alloy powder.

After obtaining the rare earth alloy powder, a lubricant, present at 0.1 wt. %, is added to the rare earth alloy powder. Next, the rare earth alloy powder including the lubricant is pulverized using a jet milling process to produce a fine alloy powder having an average particle size of between 2.8 μm. After obtaining the fine alloy powder, the lubricant is further added to the fine alloy powder in an amount between 0.05 wt. %. Next, the fine alloy powder including the lubricant is mixed using a mixer for a mixing duration of 2 hours. After mixing, the fine alloy powders including the lubricant are compacted in a mold and oriented. While orienting to the fine alloy powders including the lubricant, the fine alloy powders are subjected to a magnetic field having a magnetic strength of 2.0T under an inert atmosphere of Argon to produce a green compact. Next, the green compact is sintered in a furnace under vacuum at a sintering temperature ranging 920° C. and a vacuum pressure of 5×10′ Pa for a sintering duration of between 6 hours to obtain a sintered magnet.

Then, the sintered magnet is cooled to room temperature at the vacuum pressure. After cooling the sintered magnet, the sintered magnet is subjected to an annealing treatment. The annealing treatment includes a first annealing treatment and a second annealing treatment. The sintered magnet is first subjected to a first annealing treatment at a first annealing temperature of 850° C. and the vacuum pressure. After the first annealing treatment, the first annealing temperature is maintained for a first annealing duration of 3 hours. Next, the sintered magnet is subjected to a second annealing treatment at a second annealing temperature of 525° C. and the vacuum pressure for a second annealing duration of 2 hours to obtain the sintered rare earth magnet. Throughout the method of making the sintered rare earth magnet, elements such as Carbon, Oxygen, and Nitrogen are regarded as impurities. During the steps of providing the raw powder, casting the raw powder, subjecting the sheet to the hydrogen decreptitation process, adding the lubricant, pulverizing the rare earth alloy powder, further adding the lubricant, mixing, compacting, sintering, cooling the sintered magnet, and subjecting the sintered magnet to the annealing treatment, the amount of impurities are carefully controlled to limit Carbon at 750 ppm, Oxygen at 600 ppm, and Nitrogen at 200 ppm to produce the sintered R-T-B based permanent magnet without any heavy rare earth elements.

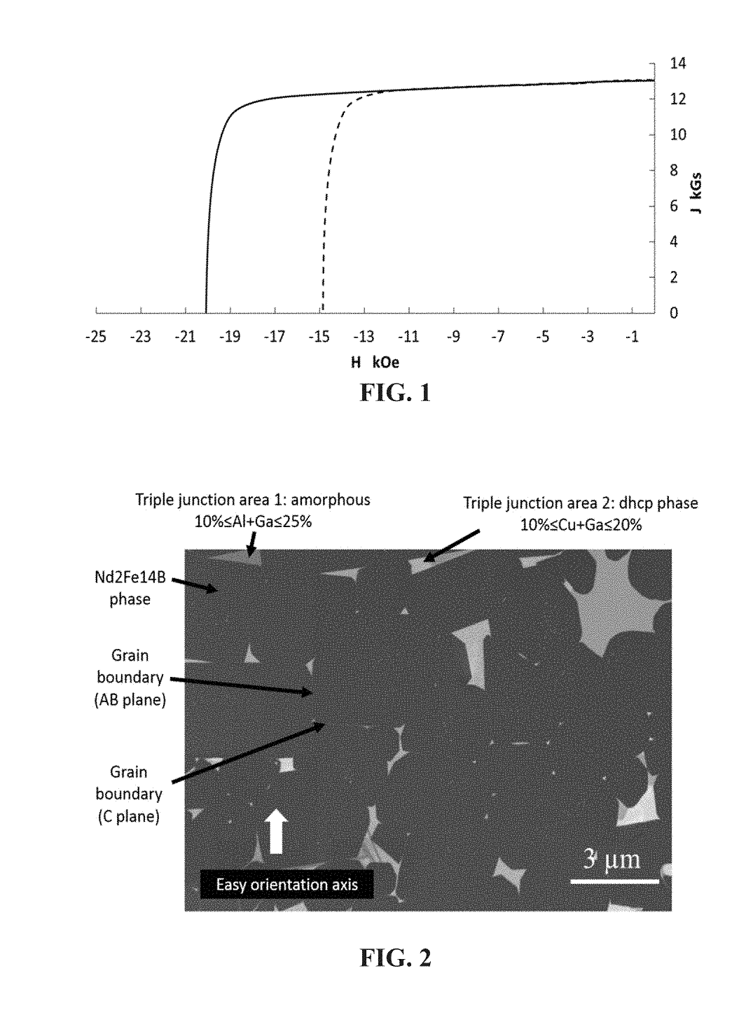

The magnetic flux density (B) and magnetic field strength (H) of the magnet of Implementing Example 1 is shown in FIG. 1. As illustrated in FIG. 1, the dash lines and solid lines represent B-H curves of an as-sintered magnet and an as-annealed magnet, respectively. The flux density (Br) and coercivity (Hcj) values of the as-sintered magnet, at room temperature, are 13.05 kGs and 14.8 kOe, respectively. With regard to the as-annealed magnet, the Br, Hcj, and squareness of the as-annealed magnet, at room temperature, are 13.0 kGs, 20.1 kOe, and 0.96, respectively.

A scanning electron microscope (SEM) image of the sintered R-T-B based permanent magnet of Implementing Example 1 is shown in FIG. 2. As illustrated in FIG. 2, the average grain size of the sintered R-T-B based permanent magnet is approximately 3.5 μm. The main phases of Nd₂Fe₁₄B, the grain boundary phases, and the grain boundary triple point areas can be distinguished based on the contrast in the SEM image. In particular, the main phases of Nd₂Fe₁₄B is in black, thin and long areas between the main phase of Nd₂Fe₁₄B are grain boundary phases, and the grain boundary triple point areas are shown in white. Within the grain boundary triple point areas, there are points having different contrast. This is an indication that potentially different structure exists in the grain boundary triple point areas.

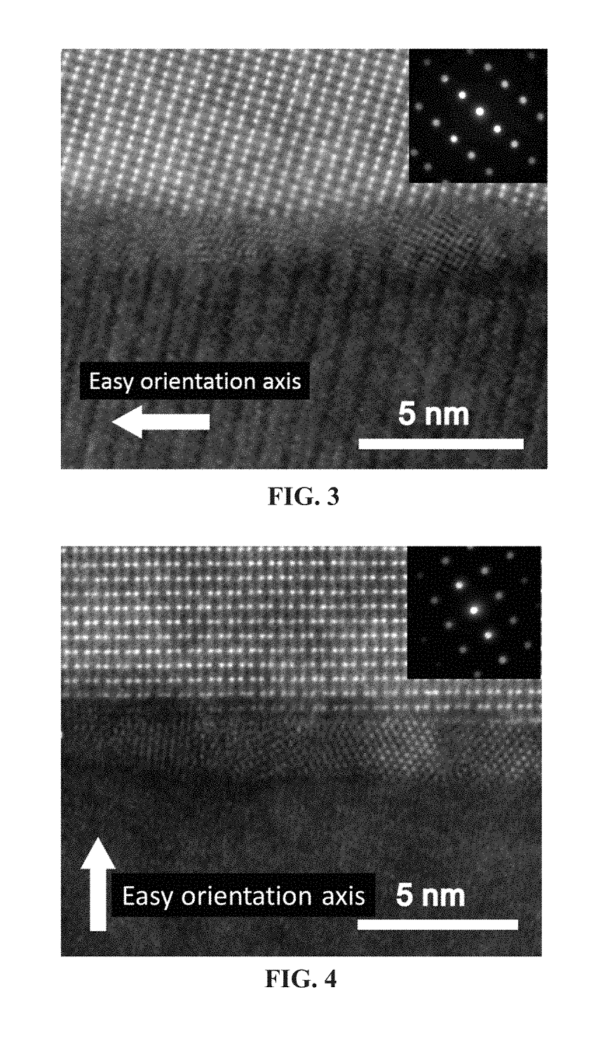

Without being bound by theory and according to recent literature, the composition and structure of the grain boundary phase of a sintered Nd—Fe—B magnet will be different due to the angle between the grain boundary and the easy-axis of orientation. Based on the different values of the angle, the grain boundary phases can be separated into a first grain boundary phase and a second grain boundary phase. The first grain boundary phase extends along an AB plane that is parallel to the easy-axis of magnetization. The second grain boundary phase extends along a second axis or a C plane that is perpendicular to the easy-axis of magnetization. FIG. 3 is a Transmission Electron Microscopy (TEM) image of the first grain boundary phase of the sintered R-T-B based permanent magnet of Implementing Example 1 along and parallel to the easy-axis of magnetization, e.g. the AB plane. FIG. 4 is a TEM image of the second grain boundary phase of the sintered R-T-B based permanent magnet of Implementing Example 1 along the second axis or the C plane extending perpendicular to the easy-axis of magnetization. Based on the analysis of the TEM's electron diffraction spots of the grain boundary phases and the calculation of the lattice constant, it is clear that the first grain boundary phase and the second grain boundary phase all have a face centered cubic crystalline structure. The measured lattice constant is approximately 0.56 nm and the thickness of the grain boundary phases is approximately 3 nm.

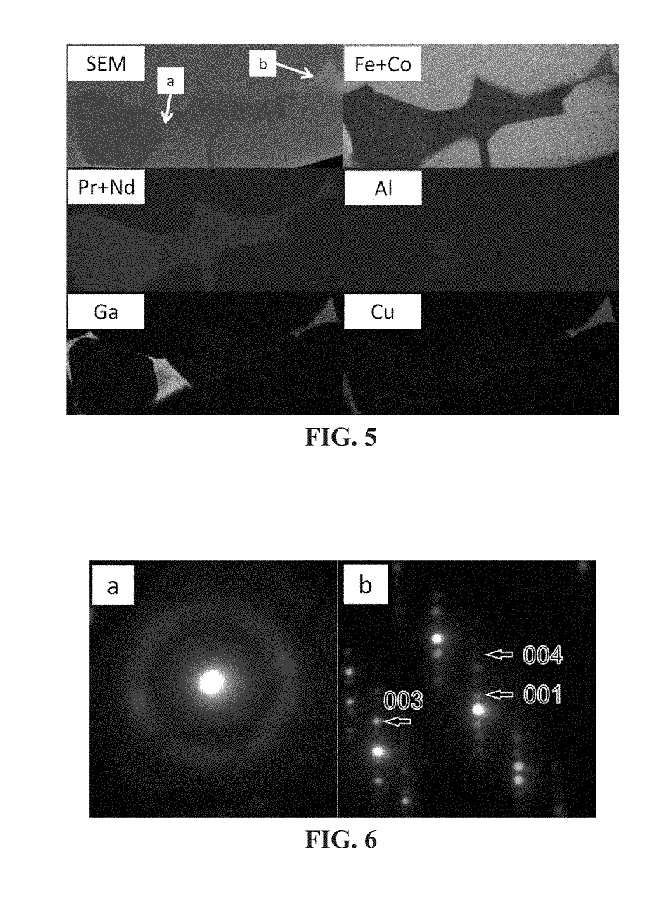

TEM is also used to obtain specific details on the composition and structural of the grain boundary triple point areas of the sintered R-T-B based permanent magnet of Implementing Example 1 under high magnification. FIG. 5 is an Electron Dispersion X-ray Spectroscopy (EDS) mapping of the sintered R-T-B based permanent magnet of Implementing Example 1 obtained from the EDS component of the TEM. As illustrated in FIG. 5, region a) is a first grain boundary triple point area which includes a high concentration of Al and Ga. In addition, as illustrated in FIG. 5, region b) is a second grain boundary triple point area which includes a high concentration of Cu and Ga. FIG. 6 is an election spot diffraction of the first grain boundary triple point area, region a), and the second grain boundary triple point area, region b), in FIG. 5. As illustrated in FIG. 6, the first grain boundary triple point area, region a), has an amorphous crystalline structure and the second grain boundary triple point area, region b), has a densely hexagonal close-packed crystalline structure (dhcp).

In addition, as clearly illustrated in FIG. 2, the thickness of the grain boundary phases of the sintered R-T-B based permanent magnet of Implementing Example 1 is uniform and continuous which is believed to be one of the reasons behind an improved squareness value of the sintered R-T-B based permanent magnet in comparison with magnets having a high concentration of Ga. Furthermore, the presence of the densely hexagonal close-packed crystalline structure of the Neodymium-rich phase of the grain boundary triple point areas distinguishes the sintered R-T-B based permanent magnet of Implementing Example 1 from magnets having a high concentration of Ga. Without being bound by theory, it is believed that, as the oxygen content in a magnet increases, the structure of the rare earth element-rich phase will gradually changes. For example, when the oxygen content is low, the densely hexagonal close-packed crystalline structure is present in a magnet having low oxygen content. As the amount of oxygen content changes in the magnet, the crystalline structure of the rare earth element-rich phase changes to face centered cubic (fcc), and, finally, hexagonal close packed structure (hcp). Comparing the Nd rich-phase having the densely hexagonal close-packed crystalline structure with the NdOₓ and Nd₂O₃ phases having a face-centered-cubic crystalline structure, because the densely hexagonal close-packed crystalline structure has a lower oxygen content, it is believed that it would be easy for the densely hexagonal close-packed crystalline structure to react with the element Cu in the sintered R-T-B based permanent magnet during the annealing treatment to allow the flow of rare earth elements into the grain boundary phases to form rare earth element rich gain boundary phases thereby increasing the coercivity of the rare earth magnet. Accordingly, to obtain this distinct microstructure, in is necessary to control the content of C, 0, and N during the method of making the making the sintered R-T-B based permanent magnet.

### Implementing Example 2

A raw powder is prepared. The raw powder includes Praseodymium (Pr) and Neodymium (Nd) being present at 14.2 at. %, Boron (B) being present at 5.0 at. %, Cobalt (Co) being present at 0.8 at. %, Copper (Cu) being present at 0.2 at. %, Aluminum (Al) being present at 0.9 at. %, Gallium being present at 0.1 at. %, and the balance being Iron (Fe). Converting the atomic percent to weight percent, it should be appreciated that the weight percentage of Pr and Nd is at 30.9 wt. %. B is at 0.8 wt. %. Co is at 0.7 wt. %. Cu is at 0.2 wt. %. Al is at 0.4 wt. %. Ga is at 0.1 wt. %. The balance is Fe.

Next, the raw powder is formed into a sheet having a thickness of between 0.2 mm and 0.5 mm using a rapid condensing strip casting process. Then, the sheet is placed into a furnace and subjected to a hydrogen decrepitation process to produce a rare earth alloy powder. The hydrogen decreptiation process is conducted under a predetermined pressure 0.2 MPa for a predetermined duration of 3.5 hours. At a predetermined temperature of 550° C., hydrogen gas is removed from the furnace during the decreptiation process to produce to the rare earth alloy powder.

After obtaining the rare earth alloy powder, a lubricant, present at 0.1 wt. %, is added to the rare earth alloy powder. Next, the rare earth alloy powder including the lubricant is pulverized using a jet milling process to produce a fine alloy powder having an average particle size of between 2.8 μm. After obtaining the fine alloy powder, the lubricant is further added to the fine alloy powder in an amount between 0.05 wt. %. Next, the fine alloy powder including the lubricant is mixed using a mixer for a mixing duration of 2 hours. After mixing, the fine alloy powders including the lubricant are compacted in a mold and oriented. While orienting to the fine alloy powders including the lubricant, the fine alloy powders are subjected to a magnetic field having a magnetic strength of 2.0T under an inert atmosphere of Argon to produce a green compact. Next, the green compact is sintered in a furnace under vacuum at a sintering temperature ranging 920° C. and a vacuum pressure of 5×10′ Pa for a sintering duration of between 6 hours to obtain a sintered magnet.

Then, the sintered magnet is cooled to room temperature at the vacuum pressure. After cooling the sintered magnet, the sintered magnet is subjected to an annealing treatment. The annealing treatment includes a first annealing treatment and a second annealing treatment. The sintered magnet is first subjected to a first annealing treatment at a first annealing temperature of 850° C. and the vacuum pressure. After the first annealing treatment, the first annealing temperature is maintained for a first annealing duration of 3 hours. Next, the sintered magnet is subjected to a second annealing treatment at a second annealing temperature of 525° C. and the vacuum pressure for a second annealing duration of 2 hours to obtain the sintered rare earth magnet. Throughout the method of making the sintered rare earth magnet, elements such as Carbon, Oxygen, and Nitrogen are regarded as impurities. During the steps of providing the raw powder, casting the raw powder, subjecting the sheet to the hydrogen decreptitation process, adding the lubricant, pulverizing the rare earth alloy powder, further adding the lubricant, mixing, compacting, sintering, cooling the sintered magnet, and subjecting the sintered magnet to the annealing treatment, the amount of impurities are carefully controlled to limit Carbon at 750 ppm, Oxygen at 600 ppm, and Nitrogen at 200 ppm to produce the sintered R-T-B based permanent magnet without any heavy rare earth elements.

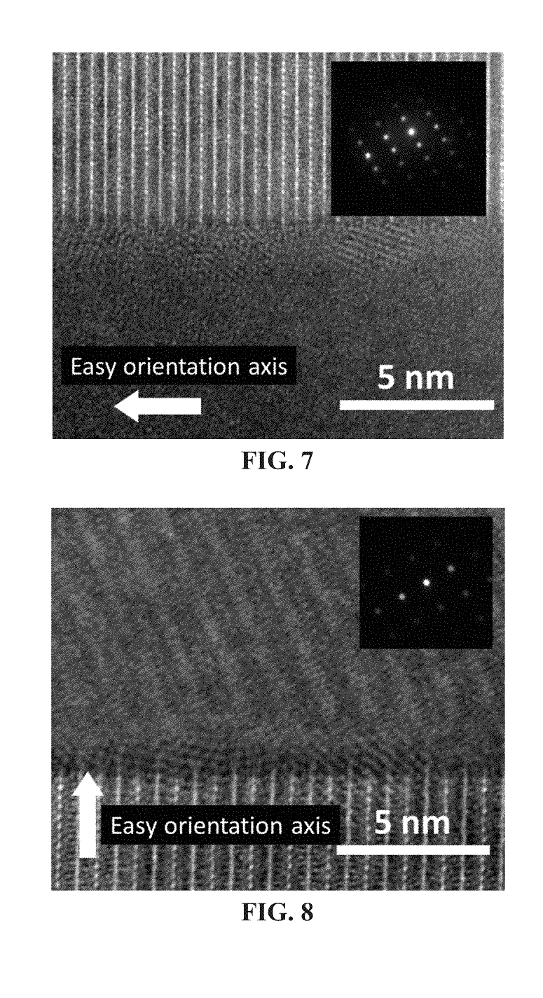

FIG. 7 is a Transmission Electron Microscopy (TEM) image of the first grain boundary phase of the sintered R-T-B based permanent magnet of Implementing Example 2 along and parallel to the easy-axis of magnetization. FIG. 8 is a TEM image of the second grain boundary phase of the sintered R-T-B based permanent magnet of Implementing Example 2 along the second axis extending perpendicular to the easy-axis of magnetization. Based on the analysis of the TEM's electron diffraction spots of the grain boundary phases and the calculation of the lattice constant, it is clear that the first grain boundary phase and the second grain boundary phase all have a face centered cubic crystalline structure.

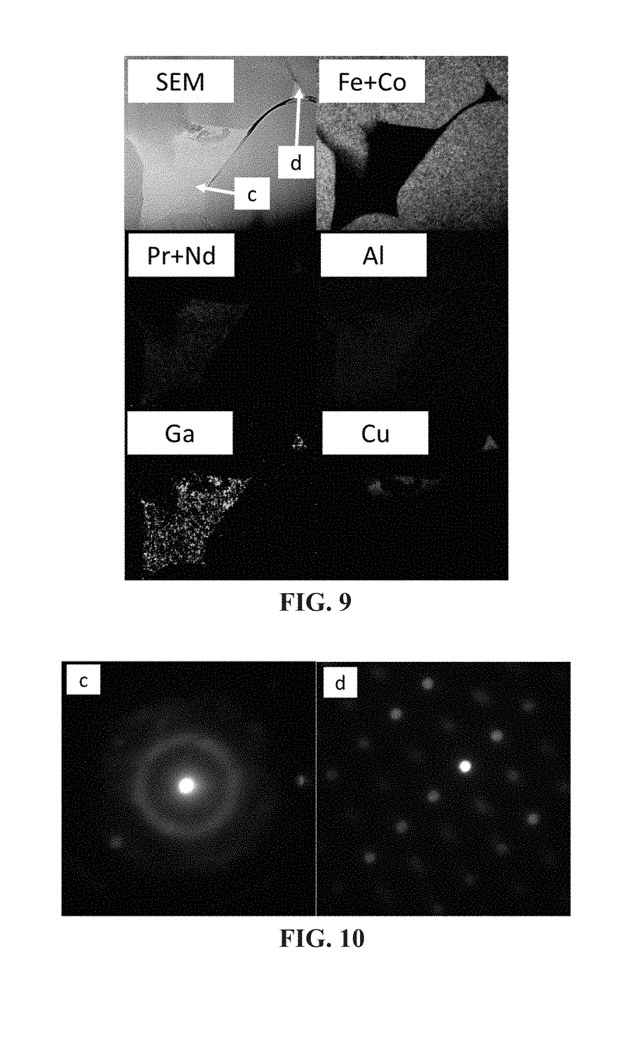

TEM is also used to obtain specific details on the composition and structural of the grain boundary triple point areas of the sintered R-T-B based permanent magnet of Implementing Example 2 under high magnification. FIG. 9 is an Electron Dispersion X-ray Spectroscopy (EDS) mapping of the sintered R-T-B based permanent magnet of Implementing Example 2 obtained from the EDS component of the TEM. As illustrated in FIG. 9, region c) is a first grain boundary triple point area which includes a high concentration of Al and Ga. In addition, as illustrated in FIG. 9, region d) is a second grain boundary triple point area which includes a high concentration of Cu and Ga. FIG. 10 is an election spot diffraction of the first grain boundary triple point area, region c), and the second grain boundary triple point area, region d), in FIG. 9. As illustrated in FIG. 6, the first grain boundary triple point area, region c), has an amorphous crystalline structure and the second grain boundary triple point area, region d), has a densely hexagonal close-packed crystalline structure (dhcp).

### Implementing Example 3

A raw powder is prepared. The raw powder includes Praseodymium (Pr) and Neodymium (Nd) being present at 15.8 at. %, Boron (B) being present at 7.3 at. %, Cobalt (Co) being present at 1.3 at. %, Copper (Cu) being present at 0.5 at. %, Aluminum (Al) being present at 1.8 at. %, Gallium being present at 0.4 at. %, and the balance being Iron (Fe). Converting the atomic percent to weight percent, it should be appreciated that the weight percentage of Pr and Nd is at 34 wt. %. B is at 1.2 wt. %. Co is at 1.2 wt. %. Cu is at 0.5 wt. %. Al is at 0.7 wt. %. Ga is at 0.4 wt. %. The balance is Fe.

Next, the raw powder is formed into a sheet having a thickness of between 0.2 mm and 0.5 mm using a rapid condensing strip casting process. Then, the sheet is placed into a furnace and subjected to a hydrogen decrepitation process to produce a rare earth alloy powder. The hydrogen decreptiation process is conducted under a predetermined pressure 0.2 MPa for a predetermined duration of 3.5 hours. At a predetermined temperature of 550° C., hydrogen gas is removed from the furnace during the decreptiation process to produce to the rare earth alloy powder.

After obtaining the rare earth alloy powder, a lubricant, present at 0.1 wt. %, is added to the rare earth alloy powder. Next, the rare earth alloy powder including the lubricant is pulverized using a jet milling process to produce a fine alloy powder having an average particle size of between 2.8 μm. After obtaining the fine alloy powder, the lubricant is further added to the fine alloy powder in an amount between 0.05 wt. %. Next, the fine alloy powder including the lubricant is mixed using a mixer for a mixing duration of 2 hours. After mixing, the fine alloy powders including the lubricant are compacted in a mold and oriented. While orienting to the fine alloy powders including the lubricant, the fine alloy powders are subjected to a magnetic field having a magnetic strength of 2.0T under an inert atmosphere of Argon to produce a green compact. Next, the green compact is sintered in a furnace under vacuum at a sintering temperature ranging 920° C. and a vacuum pressure of 5×10′ Pa for a sintering duration of between 6 hours to obtain a sintered magnet.

Then, the sintered magnet is cooled to room temperature at the vacuum pressure. After cooling the sintered magnet, the sintered magnet is subjected to an annealing treatment. The annealing treatment includes a first annealing treatment and a second annealing treatment. The sintered magnet is first subjected to a first annealing treatment at a first annealing temperature of 850° C. and the vacuum pressure. After the first annealing treatment, the first annealing temperature is maintained for a first annealing duration of 3 hours. Next, the sintered magnet is subjected to a second annealing treatment at a second annealing temperature of 525° C. and the vacuum pressure for a second annealing duration of 2 hours to obtain the sintered rare earth magnet. Throughout the method of making the sintered rare earth magnet, elements such as Carbon, Oxygen, and Nitrogen are regarded as impurities. During the steps of providing the raw powder, casting the raw powder, subjecting the sheet to the hydrogen decreptitation process, adding the lubricant, pulverizing the rare earth alloy powder, further adding the lubricant, mixing, compacting, sintering, cooling the sintered magnet, and subjecting the sintered magnet to the annealing treatment, the amount of impurities are carefully controlled to limit Carbon at 750 ppm, Oxygen at 600 ppm, and Nitrogen at 200 ppm to produce the sintered R-T-B based permanent magnet without any heavy rare earth elements.

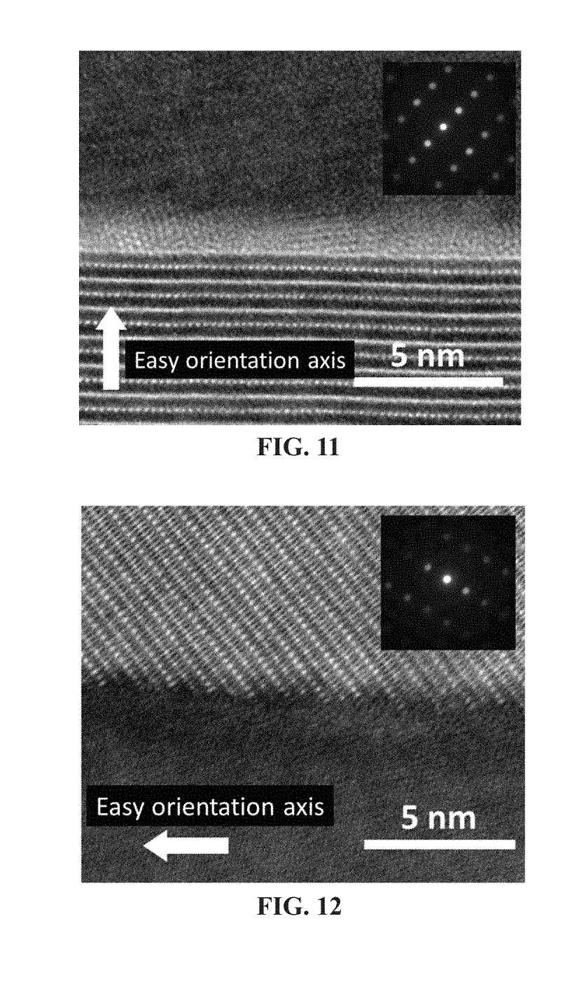

FIG. 11 is a Transmission Electron Microscopy (TEM) image of the first grain boundary phase of the sintered R-T-B based permanent magnet of Implementing Example 3 along and parallel to the easy-axis of magnetization. FIG. 12 is a TEM image of the second grain boundary phase of the sintered R-T-B based permanent magnet of Implementing Example 3 along the second axis extending perpendicular to the easy-axis of magnetization. Based on the analysis of the TEM's electron diffraction spots of the grain boundary phases and the calculation of the lattice constant, it is clear that the first grain boundary phase and the second grain boundary phase all have a face centered cubic crystalline structure.

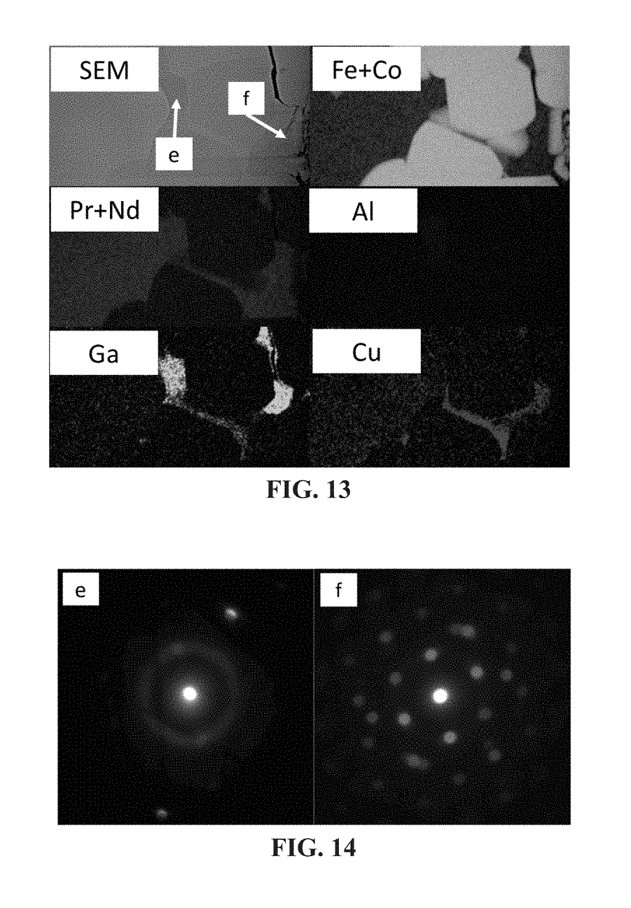

TEM is also used to obtain specific details on the composition and structural of the grain boundary triple point areas of the sintered R-T-B based permanent magnet of Implementing Example 3 under high magnification. FIG. 13 is an Electron Dispersion X-ray Spectroscopy (EDS) mapping of the sintered R-T-B based permanent magnet of Implementing Example 3 obtained from the EDS component of the TEM. As illustrated in FIG. 13, region e) is a first grain boundary triple point area which includes a high concentration of Al and Ga. In addition, as illustrated in FIG. 14, region f) is a second grain boundary triple point area which includes a high concentration of Cu and Ga. FIG. 14 is an election spot diffraction of the first grain boundary triple point area, region e), and the second grain boundary triple point area, region d), in FIG. 13. As illustrated in FIG. 14, the first grain boundary triple point area, region e), has an amorphous crystalline structure and the second grain boundary triple point area, region f), has a densely hexagonal close-packed crystalline structure (dhcp).

It should be noted that the sintered R-T-B based permanent magnet of implementing examples 2 and 3 are prepared using the same process as set forth in implementing example 1. The microstructures of the sintered R-T-B based permanent magnets of implementing examples 2 and 3 are analyzed using TEM. SEM images and selected area electron diffraction (SAED) patterns confirm that the along the AB plane, e.g. the easy-axis of orientation, and C plane, e.g. the second axis, the grain boundary phases has a face center cubic crystalline structure. The composition and the crystalline structures of the grain boundary phases of the sintered R-T-B based permanent magnet from implementing examples 1, 2, and 3 are set forth in Table 1 below. TEM equipped with an energy dispersive x-ray spectroscopy (EDS) is used to analyze the microstructure and composition of the grain boundary triple point areas of the sintered R-T-B based permanent magnets of implementing examples 1, 2, and 3. The analysis revealed that the sintered R-T-B based permanent magnets of implementing examples 1, 2, and 3 include two different grain boundary triple point areas. Table 2 below summarizes the composition and the crystalline structures of the grain boundary triple point areas of the sintered R-T-B based permanent magnets of implementing examples 1, 2, and 3.

TABLE 1
Composition and the Crystalline Structures of the Grain
Boundary Phases of the Sintered R-T-B based Permanent
Magnet from Implementing Examples 1, 2, and 3

| Implementing | | | | | | | | | | AB | C |
|---|---|---|---|---|---|---|---|---|---|---|---|
| Examples | | Pr | Nd | B | Co | Cu | Al | Ga | Fe | Plane | Plane |
| 1 | wt. % | 7.0 | 25.5 | 0.9 | 1.0 | 0.4 | 0.4 | 0.2 | Bal- | Fcc | Fcc |
| | at. % | 3.3 | 11.7 | 5.6 | 1.1 | 0.4 | 1.0 | 0.2 | ance | struc- | struc- |
| 2 | wt. % | 6.6 | 24.3 | 0.8 | 0.7 | 0.2 | 0.4 | 0.1 | | ture | ture |
| | at. % | 3.1 | 11.1 | 5.0 | 0.8 | 0.2 | 0.9 | 0.1 | | | |
| 3 | wt. % | 7.3 | 26.7 | 1.2 | 1.2 | 0.5 | 0.7 | 0.4 | | | |
| | at. % | 3.4 | 12.2 | 7.3 | 1.3 | 0.5 | 1.8 | 0.4 | | | |

TABLE 2
Composition and the Crystalline Structures of the Grain
Boundary Triple Point Phases of the Sintered R-T-B based
Permanent Magnet from Implementing Examples 1, 2, and 3

| | Implementing | | Pr + | | | | | | |
|---|---|---|---|---|---|---|---|---|---|
| Areas | Examples | | Nd | Co | Cu | Al | Ga | Fe | O |
| dhcp phase | 1 | wt. % | 82.1 | 1.5 | 5.1 | 0.6 | 3.3 | 6.6 | 0.8 |
| | | at. % | 62.4 | 2.7 | 8.8 | 2.6 | 5.1 | 13.0 | 5.4 |
| | 2 | wt. % | 79.5 | 1.5 | 3.8 | 1.4 | 3.4 | 9.1 | 1.4 |
| | | at. % | 56.0 | 2.5 | 6.1 | 5.2 | 4.9 | 16.5 | 8.8 |
| | 3 | wt. % | 84.2 | 1.3 | 5.5 | 0.6 | 4.3 | 3.8 | 0.2 |
| | | at. % | 68.0 | 2.6 | 10.1 | 2.7 | 7.2 | 7.9 | 1.5 |
| Amorphous | 1 | wt. % | 89.9 | 0.2 | 0.4 | 1.6 | 6.6 | 0.7 | 0.7 |
| phase | | at. % | 74.1 | 0.3 | 0.8 | 7.1 | 11.2 | 1.4 | 5.1 |
| | 2 | wt. % | 85.2 | 0.1 | 0.4 | 1.5 | 11.2 | 0.6 | 1.1 |
| | | at. % | 66.2 | 0.1 | 0.7 | 6.2 | 17.8 | 1.1 | 7.9 |
| | 3 | wt. % | 93.7 | 0.1 | 0.1 | 0.9 | 5.0 | 0.1 | 0.1 |
| | | at. % | 85.1 | 0.2 | 0.2 | 4.5 | 9.3 | 0.3 | 0.4 |

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A sintered R-T-B based permanent magnet comprising:
a body having an easy-axis of magnetization including a plurality of R₂T₁₄B main phases spaced from one another and a plurality of grain boundary phases disposed between said R₂T₁₄B main phases; and
said body including zero heavy rare earth elements and said grain boundary phases including a first grain boundary phase and a second grain boundary phase with said first grain boundary phase disposed between said R₂T₁₄B main phases and extending along and parallel to said easy-axis of magnetization whereby said first grain boundary phase forms a plurality of first grain boundary triple point areas with said first grain boundary triple point areas being a rare earth element rich phase having a high content of Al and Ga and including 65 at. %≤Pr+Nd≤88 at. %, 10 at. %≤Al+Ga≤25 at. %, O≤10 at. %, and Fe+Cu+Co≤2 at. %.

2. The sintered R-T-B based permanent magnet as set forth in claim 1 wherein said first grain boundary phase has a face-centered cubic crystalline structure.

3. The sintered R-T-B based permanent magnet as set forth in claim 1 wherein said first grain boundary triple point areas has an amorphous crystalline structure.

4. The sintered R-T-B based permanent magnet as set forth in claim 2 wherein said second grain boundary phase is disposed between said R₂T₁₄B main phases and extends along a second axis perpendicular to said easy-axis of magnetization forming a plurality of second grain boundary triple point areas with said second grain boundary triple point areas being a rare earth element rich phase having a high content of Cu and Ga and including 50 at. %≤Pr+Nd≤70 at. %, 10 at. %≤Cu+Ga≤10 at. %, O≤10 at. %, and 10 at. %≤Fe+Cu+Co≤20 at. %

5. The sintered R-T-B based permanent magnet as set forth in claim 4 wherein said second grain boundary phase has a face-centered cubic crystalline structure.

6. The sintered R-T-B based permanent magnet as set forth in claim 4 wherein said second grain boundary triple points has a densely hexagonal close-packed crystalline structure.

7. The sintered R-T-B based permanent magnet as set forth in claim 1 wherein said body having a composition of R-T-B-M with R being one or more rare earth elements selected from a group consisting of Pr or Nd, T being one or more transition metals selected from a group consisting of Fe or Co, B being one or more elements selected from a group consisting of B, C, O, or N, and M being one or more elements selected from a group consisting of Al, Cu, or Ga.

8. The sintered R-T-B based permanent magnet as set forth in claim 7 wherein R includes Pr and Nd, T includes Fe and Co, B includes B, C, O, and N, and M includes Al, Cu, and Ga.

9. The sintered R-T-B based permanent magnet as set forth in claim 7 wherein C≤800 ppm, O≤800 ppm, and N≤200 ppm.

10. The sintered R-T-B based permanent magnet as set forth in claim 8 wherein Pr and Nd are present between 14.2 at. % and 15.6 at. %, Boron is present between 4.9 at. % and 7.3 at. %, Aluminum is present between 0.9 at. % and 2.0 at. %, Cobalt is present between 0.1 at. % and 1.3 at. %, Copper is between 0.2 at. % and 0.5 at. %, Gallium is present between 0.1 at. % and 0.4 at. %, and the remainder is Iron.

11. A method of making a sintered R-T-B based permanent magnet without any heavy rare earth elements, said method comprising the steps of:
providing a raw powder;
forming the raw powder into a sheet;
subjecting the sheet to a hydrogen decrepitation process to produce a rare earth alloy powder;
adding a lubricant to the rare earth alloy powder;
pulverizing the rare earth alloy powder including the lubricant to produce a fine alloy powder;
further adding the lubricant to the fine alloy powder;
mixing the fine alloy powder including the lubricant;
compacting the fine alloy powder including the lubricant and orienting the fine alloy powder under an inert atmosphere of Argon to produce a green compact;
sintering the green compact in a furnace under vacuum to obtain a sintered magnet;
subjecting the sintered magnet to an annealing treatment; and
controlling the amount of impurities during said steps of providing the raw powder, forming the raw powder, subjecting the sheet to the hydrogen decreptitation process, adding the lubricant, pulverizing the rare earth alloy powder, further adding the lubricant, mixing, compacting, sintering, cooling the sintered magnet, and subjecting the sintered magnet to the annealing treatment to limit Carbon ≤800 ppm and Oxygen ≤800 ppm and Nitrogen ≤200 ppm to produce the sintered R-T-B based permanent magnet without any heavy rare earth elements.

12. The method as set forth in claim 11 wherein said step of subjecting the sintered magnet to the annealing treatment is further defined as subjecting the sintered magnet to a first annealing treatment after said step of cooling at a first annealing temperature of between 780° C. and 860° C. and a vacuum pressure of 5×10⁻² Pa.

13. The method as set forth in claim 12 wherein said step of subjecting the sintered magnet to the annealing treatment further including a step of maintaining the first annealing temperature and the vacuum for a first annealing duration of 3 hours.

14. The method as set forth in claim 13 wherein said step of subjecting the sintered magnet to the annealing treatment further including a second annealing treatment after the first annealing treatment at a second annealing temperature of between 480° C. and 550° C. and the vacuum pressure for a second annealing duration of between 2 hours to 8 hours.

15. The method as set forth in claim 11 wherein said step of sintering is further defined as sintering the green compact in a furnace under vacuum at a sintering temperature ranging between 880° C. and 1030° C. and a vacuum pressure of 5×10⁻² Pa for a sintering duration of between 6 hours to 15 hours to obtain a sintered magnet.

16. The method as set forth in claim 15 wherein said step of sintering further includes a step of cooling the sintered magnet to room temperature at the vacuum pressure.

17. The method as set forth in claim 11 wherein said step of providing the raw powder is further defined as providing a including Praseodymium and Neodymium being present between 14.2 at. % and 15.6 at. %, Boron being present between 4.9 at. % and 7.3 at. %, Aluminum being present between 0.9 at. % and 2.0 at. %, Cobalt being present between 0.1 at. % and 1.3 at. %, Copper being between 0.2 at. % and 0.5 at. %, Gallium being present between 0.1 at. % and 0.4 at. %, and with the remainder being Iron.

18. The method as set forth in claim 11 wherein said step of forming the raw powder is further defined as casting the raw powder into a sheet having a thickness of between 0.2 mm and 0.5 mm using a rapid condensing strip casting process.

19. The method as set forth in claim 18 wherein said step of subjecting the sheet to the hydrogen decrepitation process is further defined as subjecting the sheet to the hydrogen decrepitation process under a predetermined pressure 0.15 MPa and 0.3 MPa for a predetermined duration of 3.5 hours to allow the sheet to absorb hydrogen.

20. A sintered R-T-B based permanent magnet comprising:
a body having a composition of R-T-B-M with R being one or more rare earth elements selected from a group consisting of Pr or Nd, T being one or more transition metals selected from a group consisting of Fe or Co, B being one or more elements selected from a group consisting of B, C, O, or N, and M being one or more elements selected from a group consisting of Al, Cu, or Ga whereby amount of C and O and N satisfies C≤800 ppm, O≤800 ppm, and N≤200 ppm;
said body having an easy-axis of magnetization and including a plurality of R₂T₁₄B main phases spaced from one another and grain boundary phases disposed between said R₂T₁₄B main phases;
said grain boundary phases including a first grain boundary phase having a face-centered cubic crystalline structure disposed between said R₂T₁₄B main phases and extending along and parallel to said easy-axis of magnetization defining a plurality of first grain boundary triple point areas with said first grain boundary triple point areas having an amorphous crystalline structure and being a rare earth element rich phase having a high content of Al and Ga and including 65 at. %≤Pr+Nd≤88 at. %, 10 at. %≤Al+Ga≤25 at. %, O≤10 at. %, Fe+Cu+Co≤2 at. %; and
said grain boundary phases including a second grain boundary phase having a face-centered cubic crystalline structure disposed between said R₂T₁₄B main phases and extending along a second axis perpendicular to said easy-axis of magnetization defining a plurality of second grain boundary triple point areas with said second grain boundary triple point areas having a densely hexagonal close-packed crystalline structure and being a rare earth element rich phase having a high content of Cu and Ga and including 50 at. %≤Pr+Nd≤70 at. %, 10 at. %≤Cu+Ga≤10 at. %, O≤10 at. %, 10 at. %≤Fe+Cu+Co≤20 at. %.
